(19) United States
(12) Patent Application Publication
(10) Pub. No.: US 2019/0125128 A1
(43) Pub. Date: May 2, 2019

(54) Grill Starter

(71) Applicant: Joseph Todd DeGidio, Kemah, TX (US)

(72) Inventors: Joseph Todd DeGidio, Kemah, TX (US); Ken Fisher, Uvalde, TX (US)

(73) Assignee: Ken Fisher, Uvalde, TX (US)

(21) Appl. No.: 15/968,170

(22) Filed: May 1, 2018

Related U.S. Application Data
(60) Provisional application No. 62/492,653, filed on May 1, 2017.

(51) Int. Cl. A47J 37/07

(52) U.S. Cl. CPC A47J 37/079

(57) ABSTRACT

A grilling system including a combustion pan configured to receive and hold a plurality of combustible articles on an upper surface thereof, a cooking grid provided over the combustion pan and configured to support food over the combustible articles, and a support member coupled to an underside of the combustion pan and configured to receive and support a portable gas torch, wherein a lighting aperture is formed in the combustion pan proximate the support member to allow flame from a portable gas torch supported by the support member underneath the combustion pan to pass through to the upper surface of the combustion pan.

### CROSS-REFERENCE TO RELATED APPLICATIONS

This application claims the benefit of U.S. Provisional Patent Application Ser. No. 62/492,653, filed on May 1, 2017, which is incorporated herein in its entirety by reference.

### FIELD OF INVENTION

The present general inventive concept relates to a grilling system, and, more particularly, to a grilling system having an integrated starter to light combustible solid fuel.

### BACKGROUND

Typically, people who enjoy cooking on an outdoor barbecue fall into one of two groups: those who prefer the relative convenience of cooking with gas; and those who prefer the improved taste of cooking with charcoal or other combustible solids. Conventional gas grills normally include push-button igniters that create a spark to light gas fuel to initiate the burning of the gas by way of gas burners provided under the grill surface. However, with charcoal cooking such a spark is not sufficient to light the coals, and a flame is typically required to be applied to the coals with a match, hand-held lighter, or the like. This can be inconvenient for a number of reasons. One inconvenience of such a system is that one is required to always have matches or a light around, and such small items are prone to be missing when needed. Also, such flames can be difficult to use on a windy day, or if they have gotten wet. Another dangerous inconvenience is that a user typically has to bring his/her hand in close proximity to the coals or to get the flame to contact them, and when a burning agent such as lighter fluid has been applied to help the coals catch fire, then the user is in danger of suffering burns at least on his/her hands. Further, if such a burning agent is not used on the coals or other fuel, the flame often needs to be applied for longer than the user may be able to comfortably hold the flame in proximity to the fuel.

Therefore, there exists a need for a more convenient and safer way to light grills using combustible solids as fuel.

### BRIEF SUMMARY

According to various example embodiments of the present general inventive concept, a grill system is provided that includes a portable torch support on the underside of the grill which will allow a user to light the combustible solid fuel in the grill in a convenient way from underneath the grill.

Additional aspects and advantages of the present general inventive concept will be set forth in part in the description which follows, and, in part, will be obvious from the description, or may be learned by practice of the present general inventive concept.

The foregoing and/or other aspects and advantages of the present general inventive concept may be achieved by providing a grilling system including a combustion pan configured to receive and hold a plurality of combustible articles on an upper surface thereof, a cooking grid provided over the combustion pan and configured to support food over the combustible articles, and a support member coupled to an underside of the combustion pan and configured to receive and support a portable gas torch, wherein a lighting aperture is formed in the combustion pan proximate the support member to allow flame from a portable gas torch supported by the support member underneath the combustion pan to pass through to the upper surface of the combustion pan.

The foregoing and/or other aspects and advantages of the present general inventive concept may also be achieved by providing a grilling system including a combustion pan configured to receive and hold a plurality of combustible articles on an upper surface thereof, a cooking grid provided over the combustion pan and configured to support food over the combustible articles, a lighting aperture formed in the combustion pan, and a portable gas torch detachably coupled to the lighting aperture, the lighting aperture being configured to allow flame from the portable gas torch to pass through to the upper surface of the combustion pan.

Other features and aspects may be apparent from the following detailed description, the drawings, and the claims.

### BRIEF DESCRIPTION OF THE FIGURES

The following example embodiments are representative of example techniques and structures designed to carry out the objects of the present general inventive concept, but the present general inventive concept is not limited to these example embodiments. In the accompanying drawings and illustrations, the sizes and relative sizes, shapes, and qualities of lines, entities, and regions may be exaggerated for clarity. A wide variety of additional embodiments will be more readily understood and appreciated through the following detailed description of the example embodiments, with reference to the accompanying drawings in which:

FIG. 1 illustrates a perspective view of a grill system according to an example embodiment of the present general inventive concept;

FIG. 2 illustrates a side view of the grill system of FIG. 1;

FIG. 3 illustrates an exploded view of a support member of the grill system of FIG. 1 according to an example embodiment of the present general inventive concept; and

FIG. 4 illustrates a partial exploded view of the grill system of FIG. 1 according an example embodiment of the present general inventive concept.

### DETAILED DESCRIPTION

Reference will now be made to the example embodiments of the present general inventive concept, examples of which are illustrated in the accompanying drawings and illustrations. The example embodiments are described herein in order to explain the present general inventive concept by referring to the figures.

The following detailed description is provided to assist the reader in gaining a comprehensive understanding of the structures and fabrication techniques described herein. Accordingly, various changes, modification, and equivalents of the structures and fabrication techniques described herein will be suggested to those of ordinary skill in the art. The progression of fabrication operations described are merely examples, however, and the sequence type of operations is not limited to that set forth herein and may be changed as is known in the art, with the exception of operations necessarily occurring in a certain order. Also, description of well-known functions and constructions may be simplified and/or omitted for increased clarity and conciseness.

Note that spatially relative terms, such as “up,” “down,” “right,” “left,” “beneath,” “below,” “lower,” “above,” “upper” and the like, may be used herein for ease of description to describe one element or feature's relationship to another element(s) or feature(s) as illustrated in the figures. Spatially relative terms are intended to encompass different orientations of the device in use or operation in addition to the orientation depicted in the figures. For example, if the device in the figures is turned over or rotated, elements described as “below” or “beneath” other elements or features would then be oriented “above” the other elements or features. Thus, the exemplary term “below” can encompass both an orientation of above and below. The device may be otherwise oriented (rotated 90 degrees or at other orientations) and the spatially relative descriptors used herein interpreted accordingly.

According to various example embodiments of the present general inventive concept, a grill system is provided that includes a portable torch support on the underside of the grill which will allow a user to light combustible solid fuel in the grill, in a convenient way, from underneath the grill. In this description, combustible solid fuel refers to any solid articles used in a combustion pan of a grill, such as charcoal, wood, etc., that produces an open flame over which food on a cooking grid is heated. The described combustion pan may be otherwise referred to as a charcoal pan, cooker bowl, charcoal chamber, etc. However, it is understood that many fuels besides charcoal may be used to produce such a flame to heat and cook the food above. Additionally, the lighting elements of this system are not limited to grills. Elevated basins such as those used for holding charcoal or other fuels to grill over are also typically used for fire pits and similar applications, and the portable torch support described herein could easily be incorporated into such a device or arrangement. Various example embodiments of the present general inventive concept are configured for use with KUDU Safari Braai™ brand grills and all related styles of grills.

The portable gas torches referred to herein may be any of a number of gas fuel containers. Such torches may be small handheld cylinders, or may be larger bottles with flexible hoses attached, and may be filled with propane, butane, etc. Also, the present general inventive concept is not limited to such portable torches. Various example embodiments may employ larger gas tanks such as the propane tanks used in conventional gas grills.

A grill according to the present general inventive concept may include a chamber in which a solid combustible fuel such as charcoal, wood, etc., may be placed. This chamber may be referred to herein as a combustion pan. The combustion pan is provided with an opening through which a user may light the contents contained in the combustion pan from the bottom of the combustion pan. This opening may be referred to as a lighting aperture herein. In this way, using a lighting device already installed under the combustion pan, the user does not have to provide matches or a lighter of his/her own, and is also able to avoid being burned when the contents begin to flame. This is also more convenient for the user in the case in which the contents take a long time to light, as conventional matches go out too quickly, and lighters can burn out or get too hot to the touch. The lighting device installed under the combustion pan is supported by a support member that is proximate to the lighting aperture so that the lighting device is easily positioned to provide gas to the lighting aperture to be used to light the contents in the combustion pan. As the support member and lighting device may be substantially hidden under the grill, detraction from the aesthetic appearance of the grill may be minimized. According to various example embodiments of the present general inventive concept, the lighting aperture may be located anywhere along the combustion pan. However, an example embodiment in which the lighting aperture is provided proximate the center of the combustion pan may provide a preferred lighting point, as the flammable contents held in the combustion pan will typically be centrally arranged. In various other example embodiments of the present general inventive concept, such as when the bottom of the combustion pan is not flat, but rather is sloped downward to a central point, the lighting aperture may be provided offset from such a central point so as to avoid ash and/or other debris from clogging the lighting aperture. Various example embodiments of the present general inventive concept may provide one or more guard members in the lighting aperture to block such debris from falling therein.

Various example embodiments of the present general inventive concept may provide a grilling system including a combustion pan configured to receive and hold a plurality of combustible articles on an upper surface thereof, a cooking grid provided over the combustion pan and configured to support food over the combustible articles, and a support member coupled to an underside of the combustion pan and configured to receive and support a portable gas torch, wherein a lighting aperture is formed in the combustion pan proximate the support member to allow flame from a portable gas torch supported by the support member underneath the combustion pan to pass through to the upper surface of the combustion pan. As previously described, the lighting aperture is formed proximate a center of the combustion pan.

In various example embodiments of the present general inventive concept, the lighting aperture may merely accommodate the lighting end of a portable torch, be it fixed or the end of a flexible hose, so that flame from the supported lighting device may simply pass therethrough. In some example embodiments, the lighting end of the portable torch may simply rest adjacent to the lighting aperture. In other various example embodiments, the lighting aperture may include a protuberance to accept the end of the lighting device, such as a fitting extending downwardly therefrom to be coupled to a nozzle of a portable gas torch. This may provide a more secure fitting from the lighting device, and the user will not be as concerned about the lighting device being disconnected from the lighting aperture. In various example embodiments, such a fitting may secure the nozzle or other such end of the lighting device with a friction fit, and may exclude the use of the lighting device support member.

In various example embodiments of the present general inventive concept, the support member of the grilling system may include more components to aid in the passage of gas to the lighting aperture. For example, rather than just provided support for the body and/or nozzle of the lighting device, the support member may include an integrated gas line and torch head of its own. Various example embodiments of the present general inventive concept may provide a support member including a fuel line coupled at a first end to the lighting aperture, and a coupling to couple a second end of the fuel line to a nozzle of a portable gas torch. The support member may further include a valve to control supply of gas from the portable gas torch, and an igniter button to light the gas supplied from the portable gas torch such that flame is passed through the lighting aperture.

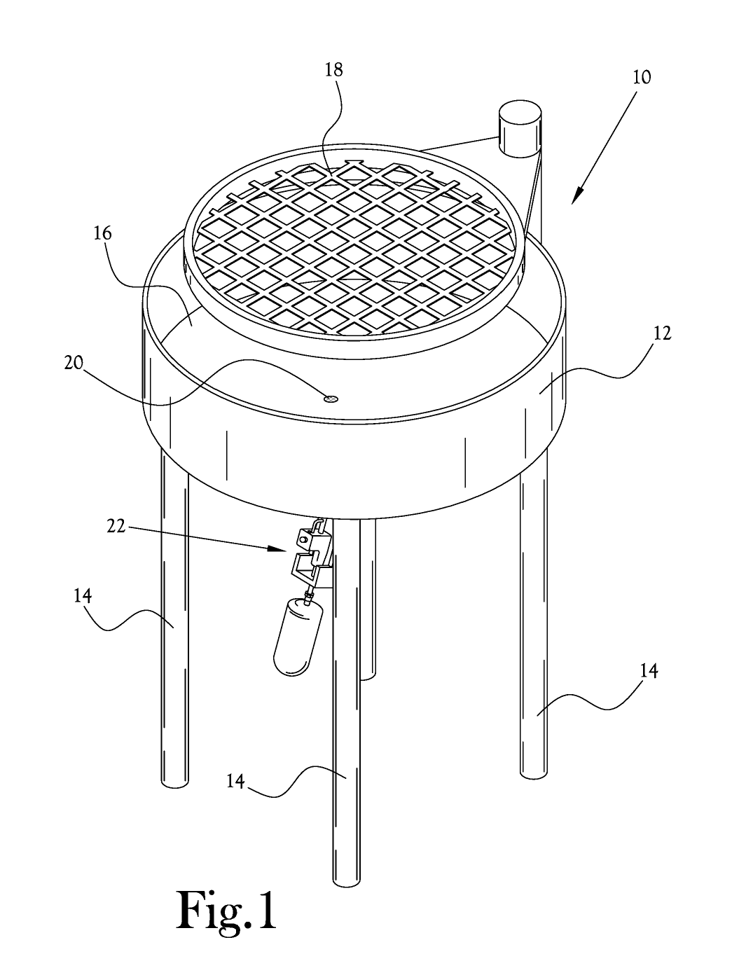

FIG. 1 illustrates a perspective view of a grill system according to an example embodiment of the present general inventive concept. In the example embodiment illustrated in FIG. 1, a grill system 10 includes a combustion pan 12 configured to be supported by a plurality of legs 14, and having an upper surface 16 to support the combustible articles to be used as fuel for cooking with the grill system 10. A cooking grid 18 is configured to rest over the combustible articles, and may be configured to be adjustable to various heights over the flame. A lighting aperture 20 is provided near a center portion of the upper surface 16 of the combustion pan 12 to allow flame from a torch assembly 22 attached to a bottom surface of the combustion pan 12. As previously described, various example embodiments may provide the lighting aperture 20 at other locations in the combustion pan 12, such as a predetermined distance off center with a rounded combustion pan, to prevent ash and other particles from entering the lighting aperture so easily.

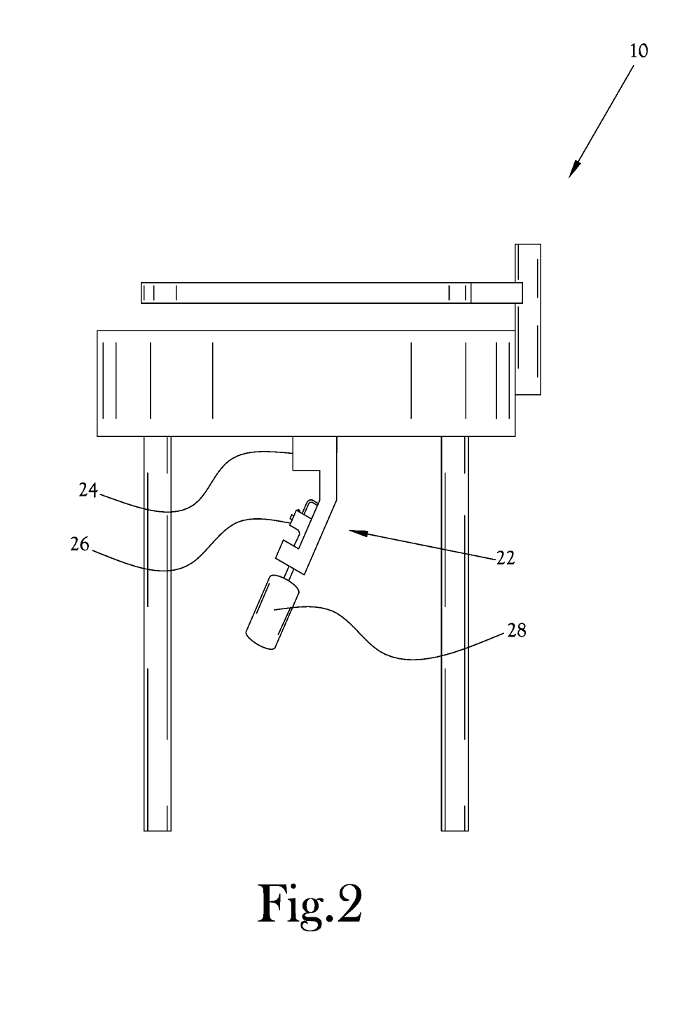

FIG. 2 illustrates a side view of the grill system of FIG. 1, which shows more detail regarding the configuration of the torch assembly 22 of the illustrated example embodiment. In this example, the torch assembly 22 includes a bracket or support member 24 fixed to the bottom surface of the combustion pan 12 to support the various components of the flame providing torch of the grill system 10. The support member 24 may be permanently fixed to the combustion pan 12, such as by welding the support member 24 to the combustion pan 12. In other various example embodiments, the support member 24 may be detachably coupled to the combustion pan 12 by various types of fittings or attachment members. A torch body 26, which itself supports an attached gas container 28, is supported in place by the support member 24 such that flame admitted by the torch assembly goes through the lighting aperture.

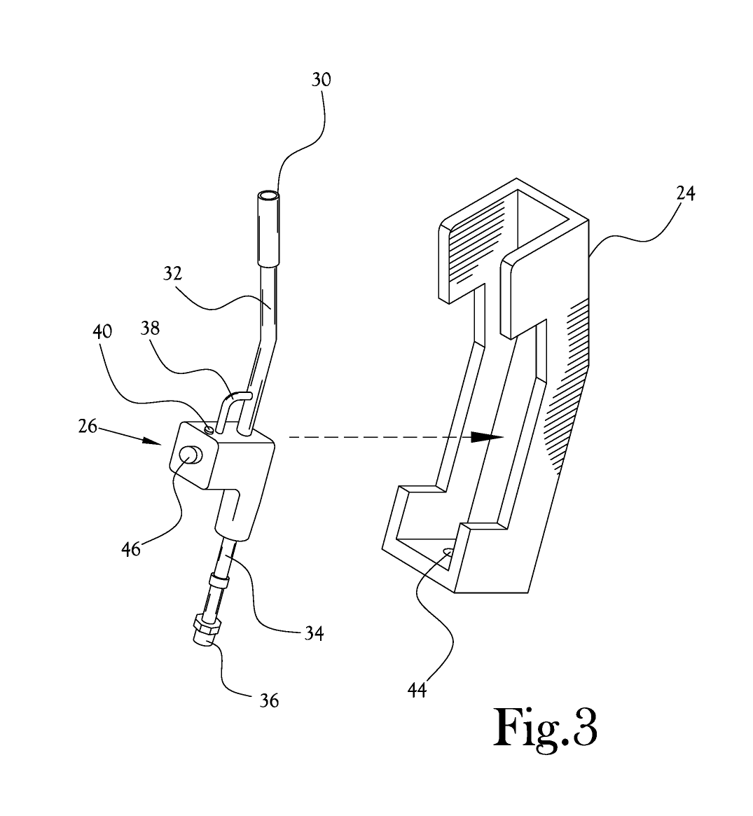

FIG. 3 illustrates an exploded view of a support member of the grill system of FIG. 1 according to an example embodiment of the present general inventive concept. In this example embodiment, the support member 24 is configured to receive and support the torch body 26. The top of the torch body is provided with a burn tip 30 which may be configured to at least partially fit through the lighting aperture 20 in a slip fit fashion. In various example embodiments the burn tip 30 may be received by an extending member extending downwardly from the lighting aperture 20, and which may hold the burn tip 30 in a slip fit. The burn tip 30 is provided at the end of a burn tube 32 that extends from an upper portion of the torch body 26, and is connected to a fuel line 38 that delivers fuel from the gas container 28 (gas bottle, etc.) through a lower fuel line 34 into the torch body 26. The gas container 28 may be fitted to the lower fuel line 24 by a lower nozzle 36, and the lower fuel line may extend through a lower fuel line aperture 44 provided in the support member 24. The torch body 26 may be provided with an igniting button 46 that may be movable between an ON and OFF position, and which may be pressed in the ON position to ignite and pass the fuel therethrough. A lock button 40 may be provided to the torch body 26 to maintain the torch flame without having to hold the igniting button 46 down. In various example embodiments of the present general inventive concept, the torch body 26 may be fixed to the support member 24 in a detachable fashion, or permanently fixed to the support member 24. In various example embodiments, the support member 24 may accommodate a torch body 26 already attached to a gas container 28, such that an off the shelf torch assembly may be used with the grill system 10. In the example embodiment illustrated in FIG. 3, the support member 24 has a receiving portion configured to receive and support at least a port of a propane bottle, a flexible nozzle of which is coupled to a fuel line provided in the support member 24.

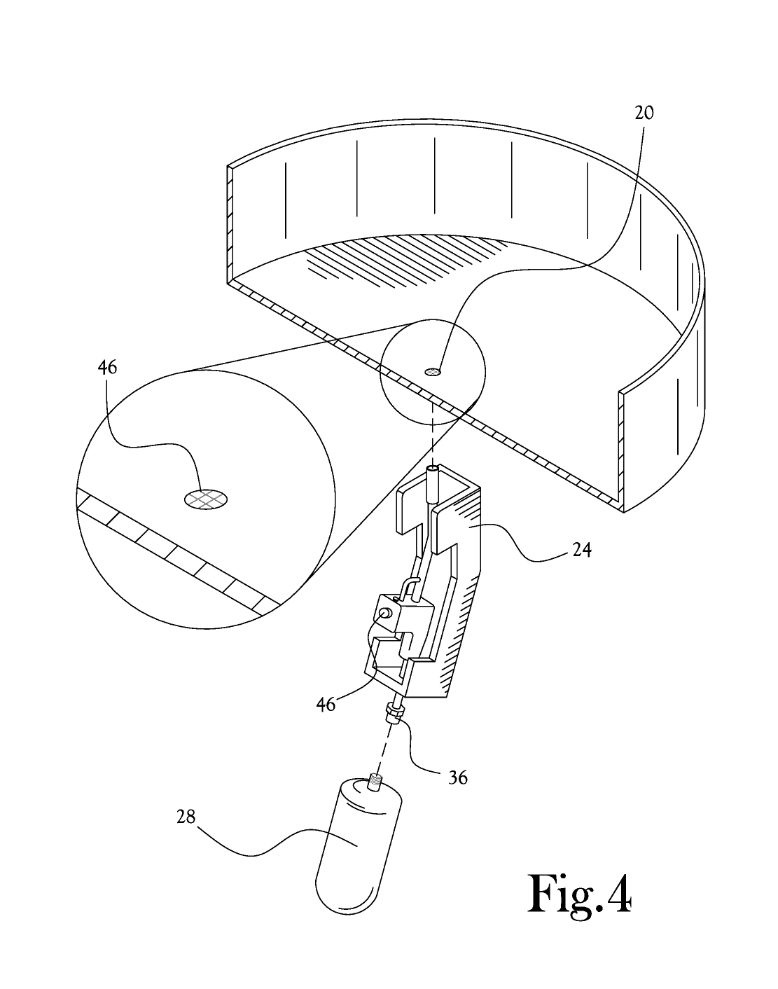

As previously discussed, various example embodiments of the present general inventive concept may include at least one guard member provided across the lighting aperture and configured to prevent debris from entering the lighting aperture. Such a guard member could be one or more crossbars to keep large debris from entering the lighting aperture. Other various example embodiments a screen with openings large enough to allow the lighting flame to pass therethrough, but small enough to block most all debris from falling therethrough. FIG. 4 illustrates a partial exploded view of the grill system of FIG. 1 according an example embodiment of the present general inventive concept. In the example embodiment illustrated in FIG. 4, a screen 46 is provided over the lighting aperture 20 to block ash and other debris. In various example embodiments, the fitting of the fuel line or lighting device to the lighting aperture may be easily uncoupled to clear debris out of the lighting aperture and/or fuel line, fuel device nozzle, etc.

Various example embodiments of the present general inventive concept may provide a grilling system including a combustion pan configured to receive and hold a plurality of combustible articles on an upper surface thereof, a cooking grid provided over the combustion pan and configured to support food over the combustible articles, and a support member coupled to an underside of the combustion pan and configured to receive and support a portable gas torch, wherein a lighting aperture is formed in the combustion pan proximate the support member to allow flame from a portable gas torch supported by the support member underneath the combustion pan to pass through to the upper surface of the combustion pan. The lighting aperture may be formed proximate a center of the combustion pan. The lighting aperture may include a fitting extending downwardly therefrom to be coupled to a nozzle of a portable gas torch. The support member may include a fuel line coupled at a first end to the lighting aperture, and a coupling to couple a second end of the fuel line to a nozzle of a portable gas torch. The support member may further include a valve to control supply of gas from the portable gas torch, and an igniter button to light the gas supplied from the portable gas torch such that flame is passed through the lighting aperture. The grilling system may further include at least one guard member provided across the lighting aperture and configured to prevent debris from entering the lighting aperture.

Various example embodiments of the present general inventive concept may provide a grilling system including a combustion pan configured to receive and hold a plurality of combustible articles on an upper surface thereof, a cooking grid provided over the combustion pan and configured to support food over the combustible articles, a lighting aperture formed in the combustion pan, and a portable gas torch detachably coupled to the lighting aperture, the lighting aperture being configured to allow flame from the portable gas torch to pass through to the upper surface of the combustion pan. The lighting aperture may be configured to hold a nozzle of the portable gas torch in a slip fit. The grilling system may further include an extending member extending downward from the lighting aperture, the extending member being configured to couple the portable gas torch thereto.

Numerous variations, modifications, and additional embodiments are possible, and accordingly, all such variations, modifications, and embodiments are to be regarded as being within the spirit and scope of the present general inventive concept. For example, regardless of the content of any portion of this application, unless clearly specified to the contrary, there is no requirement for the inclusion in any claim herein or of any application claiming priority hereto of any particular described or illustrated activity or element, any particular sequence of such activities, or any particular interrelationship of such elements. Moreover, any activity can be repeated, any activity can be performed by multiple entities, and/or any element can be duplicated.

It is noted that the simplified diagrams and drawings included in the present application do not illustrate all the various connections and assemblies of the various components, however, those skilled in the art will understand how to implement such connections and assemblies, based on the illustrated components, figures, and descriptions provided herein, using sound engineering judgment. Numerous variations, modification, and additional embodiments are possible, and, accordingly, all such variations, modifications, and embodiments are to be regarded as being within the spirit and scope of the present general inventive concept.

While the present general inventive concept has been illustrated by description of several example embodiments, and while the illustrative embodiments have been described in detail, it is not the intention of the applicant to restrict or in any way limit the scope of the general inventive concept to such descriptions and illustrations. Instead, the descriptions, drawings, and claims herein are to be regarded as illustrative in nature, and not as restrictive, and additional embodiments will readily appear to those skilled in the art upon reading the above description and drawings. Additional modifications will readily appear to those skilled in the art. Accordingly, departures may be made from such details without departing from the spirit or scope of applicant's general inventive concept.

1. A grilling system, comprising:
a combustion pan configured to receive and hold a plurality of combustible articles on an upper surface thereof;
a cooking grid provided over the combustion pan and configured to support food over the combustible articles; and
a support member coupled to an underside of the combustion pan and configured to receive and support a portable gas torch;
wherein a lighting aperture is formed in the combustion pan proximate the support member to allow flame from a portable gas torch supported by the support member underneath the combustion pan to pass through to the upper surface of the combustion pan.

2. The grilling system of claim 1, wherein the lighting aperture is formed proximate a center of the combustion pan.

3. The grilling system of claim 1, wherein the lighting aperture includes a fitting extending downwardly therefrom to be coupled to a nozzle of a portable gas torch.

4. The grilling system of claim 1, wherein the support member comprises:
a fuel line coupled at a first end to the lighting aperture; and
a coupling to couple a second end of the fuel line to a nozzle of a portable gas torch.

5. The grilling system of claim 4, wherein the support member further comprises:
a valve to control supply of gas from the portable gas torch; and
an igniter button to light the gas supplied from the portable gas torch such that flame is passed through the lighting aperture.

6. The grilling system of claim 1, further comprising at least one guard member provided across the lighting aperture and configured to prevent debris from entering the lighting aperture.

7. A grilling system, comprising:
a combustion pan configured to receive and hold a plurality of combustible articles on an upper surface thereof;
a cooking grid provided over the combustion pan and configured to support food over the combustible articles;
a lighting aperture formed in the combustion pan; and
a portable gas torch detachably coupled to the lighting aperture, the lighting aperture being configured to allow flame from the portable gas torch to pass through to the upper surface of the combustion pan.

8. The grilling system of claim 7, wherein the lighting aperture is configured to hold a nozzle of the portable gas torch in a slip fit.

9. The grilling system of claim 7, further comprising an extending member extending downward from the lighting aperture, the extending member being configured to couple the portable gas torch thereto.
